(19) United States
(12) Patent Application Publication
(10) Pub. No.: US 2026/0085237 A1
(43) Pub. Date: Mar. 26, 2026

(54) CsPbBr3 Perovskite Nanocrystal, Preparation Method Thereof, and Perovskite Film Comprising the Same

(71) Applicant: NATIONAL SUN YAT-SEN UNIVERSITY, Kaohsiung City (TW)

(72) Inventor: Shu Chen HSIEH, Kaohsiung City (TW)

(73) Assignee: NATIONAL SUN YAT-SEN UNIVERSITY, Kaohsiung City (TW)

(21) Appl. No.: 19/020,815

(22) Filed: Jan. 14, 2025

(30) Foreign Application Priority Data
Sep. 26, 2024 (TW) 113136607

(51) Int. Cl. C09K 11/66; C09K 11/02

(52) U.S. Cl. CPC C09K 11/665; C09K 11/02

(57) ABSTRACT

The present disclosure provides a CsPbBr₃ perovskite nanocrystal characterized by doping with 3,4,9,10-perylenetetracarboxylic dianhydride (PTCDA), wherein the PTCDA forms bonds with the lead atoms in the CsPbBr₃ perovskite nanocrystal via the oxygen atoms of the C═O group. The present disclosure also provides a preparation method of the foregoing CsPbBr₃ perovskite nanocrystal, characterized by adding PTCDA when preparing the CsPbBr₃ perovskite precursor solution. Furthermore, the present disclosure provides a perovskite film comprising the foregoing CsPbBr₃ perovskite nanocrystal. With the method of doping PTCDA into CsPbBr₃ perovskite according to the present disclosure, a CsPbBr₃ perovskite doped with PTCDA with reduced defect density, enhanced stability in high-humidity environments, and simultaneously having improved electron transport capability can be obtained.

### CROSS-REFERENCE TO RELATED APPLICATIONS

This application claims the benefit of priority of Taiwan Application Number TW113136607, filed 26 Sep. 2024, which is herein incorporated by reference in its entirety.

### TECHNICAL FIELD

The present disclosure relates to perovskite. Specifically, the present disclosure relates to CsPbBr₃ perovskite doped with 3,4,9,10-perylenetetracarboxylic dianhydride (PTCDA).

### BACKGROUND

The inorganic perovskite CsPbBr₃ is a semiconductor material with excellent semiconductor properties, great ionic conductivity, great light absorption rate, and low cost, and so on, making it widely used in photodetectors, light-emitting diodes, and solar cells, and so on. However, during the growth process, defects can easily form on the uneven crystalline surface or at grain boundaries (GB) of CsPbBr₃ crystals, thereby leading to reduced device performance. Moreover, when a large number of defects present on the surface, CsPbBr₃ crystals are prone to react with water, causing the detachment of PbBr₂ compounds from the perovskite surface and forming the by-product Cs₄PbBr₆. The larger interstitial spaces in the Cs₄PbBr₆ structure allow water from the air to easily infiltrate the lattice. Water infiltration into the grain boundaries also leads to rapid degradation of the perovskite. Therefore, to enhance the stability of CsPbBr₃ perovskites in high-humidity environments, it is essential to start with interface protection and preventing grain boundary defects to improve the stability of the perovskite layer.

To this end, suitable materials can be used as additives to protect the grain boundaries. Currently known additives including pyridine, ionic liquids, organic molecules, bifunctional organic molecules, phenylalkylamines, and polymers (such as polyvinylpyrrolidone, polyethylene glycol, polystyrene) can reduce grain boundary defects and form a waterproof layer to prevent moisture infiltration, thereby improving the stability of devices in high-humidity environments. However, these technologies overlook the effect of the insulating properties of hydrophobic materials on electron transport. Therefore, there is still a need for a material that can reduce the defect density in grain boundaries, increase hydrophobicity, and simultaneously enhance electron transport within the perovskite.

3,4,9,10-Perylenetetracarboxylic dianhydride (PTCDA) is an n-type semiconductor with a larger aromatic structure, π-π interactions, visible light absorption, great charge transfer properties, and environmental stability, thus making it suitable as an organic electron transport layer (ETL) material in flexible solar cells.

A large number of under-coordinated Pb atoms are present in the CsPbBr₃; thus, providing electrons to under-coordinated Pb atoms on grain boundaries can reduce Pb vacancy defects, for example, through amino (—NH₂) or hydroxyl (—OH) groups. However, in the prior art, there is no relevant disclosure or suggestions regarding whether the carboxylate groups (COO⁻) of PTCDA can bind with the under-coordinated Pb²⁺ ions on the perovskite surface via electrostatic interactions or serving as Lewis base ligands, thereby enhancing the stability of the perovskite in high-humidity environments.

### SUMMARY

Accordingly, the present disclosure provides a CsPbBr₃ perovskite doped with PTCDA and a preparation method thereof to reduce the defect density in the CsPbBr₃ perovskite, enhance the stability of the CsPbBr₃ perovskite in high-humidity environments, and simultaneously enhance electron transport in the CsPbBr₃ perovskite.

In an aspect, the present disclosure provides a CsPbBr₃ perovskite nanocrystal, characterized in that the CsPbBr₃ perovskite nanocrystal is doped with 3,4,9,10-perylenetetracarboxylic dianhydride (PTCDA), wherein the PTCDA forms bonds with lead atom in the CsPbBr₃ perovskite nanocrystal via oxygen atom of the C═O group in the PTCDA, and is interspersed between the CsPbBr₃ perovskite nanocrystals.

In some embodiments, the absorption peak in the UV-visible absorption spectrum of the CsPbBr₃ perovskite nanocrystal is between 512 nm and 522 nm.

In some embodiments, the emission peak in the photoluminescence (PL) spectrum of the CsPbBr₃ perovskite nanocrystal is between 519 nm and 525 nm.

In some embodiments, the CsPbBr₃ perovskite nanocrystal has an average lifetime between 37 ns and 47 ns at RH75%.

In some embodiments, the potential difference between the grains and grain boundaries of the CsPbBr₃ perovskite nanocrystal at RH75% is between 1.34 mV and 1.44 mV.

In another aspect, the present disclosure provides a preparation method of the foregoing CsPbBr₃ perovskite nanocrystal, characterized by adding PTCDA when preparing CsPbBr₃ perovskite precursor solution.

In some embodiments, the method comprises the following steps:
Step 1: dissolving CsBr and PbBr₂ in a first solvent;
Step 2: adding oleic acid (OA) and oleylamine (OAM);
Step 3: adding a PTCDA solution dissolved in a second solvent, thereby forming CsPbBr₃ perovskite precursor solution;
Step 4: reacting the CsPbBr₃ perovskite precursor solution with a third solvent, thereby obtaining the CsPbBr₃ perovskite nanocrystal.

In some embodiments, the first solvent is dimethylformamide (DMF); the second solvent is dimethylformamide (DMF); and the third solvent is toluene.

In some embodiments, the PTCDA solution dissolved in a second solvent has a concentration of 4 mM to 6 mM.

In another aspect, the present disclosure provides a perovskite film comprising the foregoing CsPbBr₃ perovskite nanocrystal.

The preparation method of the present disclosure involves adding PTCDA during the synthesis process of the CsPbBr₃ perovskite precursor solution, thereby doping PTCDA into the CsPbBr₃ perovskite. By using the method of doping PTCDA into CsPbBr₃ perovskite as disclosed in the present disclosure, defects in the CsPbBr₃ perovskite can be reduced, the proportion of CsPbBr₃ within the CsPbBr₃ perovskite can be increased, and the proportion of Cs₄PbBr₆ can be decreased. This method can also effectively passivate the grain boundaries of the CsPbBr₃ perovskite, reducing charge recombination, thereby extending the lifetime of the CsPbBr₃ perovskite and promoting electron transfer between grains, which effectively mitigates electron accumulation at the grain boundaries, thus reducing the potential difference between grains and grain boundaries.

Additionally, the hydrophobicity of the conjugated structure of PTCDA allows PTCDA to form a protective layer on the perovskite surface, reducing direct contact between water molecules and the crystal surface, thereby effectively preventing degradation of the perovskite caused by reactions with water molecules in high-humidity environments. This improves the stability of CsPbBr₃ perovskite in high-humidity environments. Specifically, by using the method of doping PTCDA into CsPbBr₃ perovskite as disclosed in the present disclosure, increases in defect density of the perovskite, the rise in surface potential difference between grains and grain boundaries, and the decrease in work function in high-humidity environments can be effectively inhibited. This also suppresses the reaction between CsPbBr₃ and water that generates Cs₄PbBr₆ and enhances the energy conversion efficiency of the CsPbBr₃ perovskite in high-humidity environments, thereby extending the lifetime of the CsPbBr₃ perovskite in high-humidity environments.

Accordingly, by using the method of doping PTCDA into CsPbBr₃ perovskite as disclosed in the present disclosure, the PTCDA-doped CsPbBr₃ perovskite with reduced defect density, enhanced stability in high-humidity environments, and simultaneously having enhanced electron transport capability can be obtained.

### BRIEF DESCRIPTION OF THE DRAWINGS

FIG. 1 represents the UV-visible absorption spectra of the PTCDA-doped CsPbBr₃ perovskite nanocrystals (PTCDA-PVSK) of the present disclosure and the comparative example (PVSK).

FIG. 2 represents the photoluminescence (PL) spectra of PTCDA-PVSK of the present disclosure and PVSK.

FIG. 3A represents the Fourier-transform infrared (FTIR) spectra of PTCDA-PVSK of the present disclosure and PTCDA; and FIG. 3B represents spectra in the range of wave number 1700-1800 cm⁻¹, zoomed from FIG. 3A.

FIG. 4A represents digital images of PTCDA-PVSK of the present disclosure and PVSK under white light and UV light irradiation; and FIG. 4B represents a quantified fluorescence intensity histogram of the digital image under UV light irradiation in FIG. 4A.

FIG. 5A represents the surface morphology and the root mean square (RMS) roughness of PVSK at low humidity (RH25%); FIG. 5B represents the surface morphology and the RMS roughness of PTCDA-PVSK at low humidity (RH25%);

FIG. 5C represents the surface morphology and the RMS roughness of PVSK at high humidity (RH75%); and FIG. 5D represents the surface morphology and the RMS roughness of PTCDA-PVSK at high humidity (RH75%).

FIG. 6A represents the surface potential image of PVSK at low humidity (RH25%); FIG. 6B represents the surface potential image of PTCDA-PVSK at low humidity (RH25%); FIG. 6C represents the surface potential image of PVSK at high humidity (RH75%); and FIG. 6D represents the surface potential image of PTCDA-PVSK at high humidity (RH75%).

FIG. 7A represents the surface potential statistical histogram of PVSK at low humidity (RH25%); FIG. 7B represents the surface potential statistical histogram of PTCDA-PVSK at low humidity (RH25%); FIG. 7C represents the surface potential statistical histogram of PVSK at high humidity (RH75%); and FIG. 7D represents the surface potential statistical histogram of PTCDA-PVSK at high humidity (RH75%).

FIG. 8A represents the XRD patterns of PTCDA-PVSK of the present disclosure and PVSK at low humidity (RH25%) and high humidity (RH75%); FIG. 8B represents the zoom-in XRD patterns in a lattice angle range of 10-17° for PVSK from FIG. 8A; and FIG. 8C represents the zoom-in XRD patterns in a lattice angle range of 10-17° for PTCDA-PVSK of the present disclosure from FIG. 8A.

FIG. 9A, FIG. 9B, and FIG. 9C respectively represent the surface morphology and the RMS roughness of PVSK stored at high humidity (RH75%) at week 0, week 2, week 4; FIG. 9D, FIG. 9E, and FIG. 9F respectively represent the surface morphology and the RMS roughness of PTCDA-PVSK stored at high humidity (RH75%) at week 0, week 2, week 4; FIG. 9G, FIG. 9H, and FIG. 9I respectively represent the surface potential images of PVSK stored at high humidity (RH75%) at week 0, week 2, week 4; and FIG. 9J, FIG. 9K, and FIG. 9L respectively represent the surface potential images of PTCDA-PVSK stored at high humidity (RH75%) at week 0, week 2, week 4.

FIG. 10A represents the work function analytical graph of PVSK and PTCDA-PVSK stored at high humidity (RH75%) for 4 weeks; FIG. 10B represents the surface potential difference analytical graph of PVSK and PTCDA-PVSK stored at high humidity (RH75%) for 4 weeks; and FIG. 10C represents the defect density analytical graph of PVSK and PTCDA-PVSK stored at high humidity (RH75%) for 4 weeks.

FIG. 11A, FIG. 11B, FIG. 11C, FIG. 11D, and FIG. 11E respectively represent the adhesion distribution images of PVSK under irradiation of light with 365 nm wavelength at high humidity (RH75%) at week 0, week 1, week 2, week 3, and week 4; and FIG. 11F, FIG. 11G, FIG. 11H, FIG. 11I, and FIG. 11J respectively represent the adhesion distribution images of PTCDA-PVSK under irradiation of light with 365 nm wavelength at high humidity (RH75%) at week 0, week 1, week 2, week 3, and week 4.

FIG. 12 represents the schematic diagram of the structure of PTCDA-PVSK of the present disclosure.

### DETAILED DESCRIPTION

The specific embodiments of the present disclosure are illustrated via the following embodiments and examples, allowing the technical means provided by the present disclosure to be readily understood by those skilled in the art. It should be noted that the following embodiments and examples are provided solely to explain the present disclosure and are not intended to limit the scope of the present disclosure.

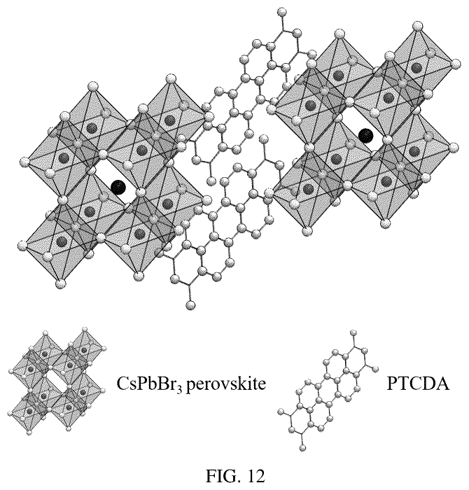

In the present disclosure, PTCDA is added as a dopant and protective agent during the process of preparing the perovskite precursor solution, and then recrystallization is followed to form the PTCDA-doped perovskite nanocrystals of the present disclosure. PTCDA forms bonds with the lead atoms in the CsPbBr₃ perovskite nanocrystals via the oxygen atoms of the C═O groups, integrating and distributing throughout the entire interior and surface of the perovskite lattice, that is, interspersing between the perovskite nanocrystals. This reduces defects in perovskite and forms a protective layer on the perovskite surface, effectively preventing degradation from reactions with water molecules in high-humidity environments via its hydrophobic properties, while simultaneously enhancing electron transport efficiency within the perovskite. The structure of the PTCDA-doped perovskite nanocrystals of the present disclosure is shown in FIG. 12.

The term “high-humidity” may refer to a humidity up to RH50%, preferably a humidity up to RH75%.

The absorption peak in the UV-visible absorption spectrum of the CsPbBr₃ perovskite nanocrystals of the present disclosure is between 512 nm and 522 nm.

The emission peak in the photoluminescence (PL) spectrum of the CsPbBr₃ perovskite nanocrystals of the present disclosure is between 519 nm and 525 nm.

The root mean square (RMS) roughness of the CsPbBr₃ perovskite nanocrystals of the present disclosure is between 32 nm and 42 nm at RH25%, and is between 39 nm and 49 nm at RH75%.

The potential difference between the grains and grain boundaries of the CsPbBr₃ perovskite nanocrystals of the present disclosure is between 0.18 mV and 0.28 mV at RH25%, and is between 1.34 mV and 1.44 mV at RH75%.

After storage of the CsPbBr₃ perovskite nanocrystals of the present disclosure at high humidity for 120 minutes, the average adhesion value of the grains increased by 0.04 nN to 0.14 nN, and the average adhesion value of the grain boundaries increased by 0.13 nN to 0.23 nN.

The preparation method of the foregoing CsPbBr₃ perovskite nanocrystals of the present disclosure includes adding PTCDA when preparing CsPbBr₃ perovskite precursor solution, wherein comprising:
Step 1: dissolving CsBr and PbBr₂ in dimethylformamide (DMF) as the first solvent, and stirring for 5 to 15 minutes;
Step 2: adding oleic acid (OA) and oleylamine (OAM), and stirring for another 5 to 15 minutes, forming a mixture;
Step 3: adding a PTCDA solution dissolved in DMF as the second solvent into the foregoing mixture, thereby forming PTCDA-doped CsPbBr₃ perovskite precursor solution;
Step 4: reacting the CsPbBr₃ perovskite precursor solution with toluene as the third solvent for 0.5 to 2 minutes, then centrifuged to remove the supernatant, thereby obtaining the PTCDA-doped CsPbBr₃ perovskite nanocrystals (PTCDA-PVSK).

In the foregoing preparation method of the CsPbBr₃ perovskite nanocrystals of the present disclosure, the molar ratio of CsBr:PbBr₂:PTCDA may be 1:1:0.002 to 1:1:0.003.

In the foregoing preparation method of the CsPbBr₃ perovskite nanocrystals of the present disclosure, the volume ratio of the first solvent in the step 1:OA in the step 2 may be 1:0.05 to 1:0.2; and the volume ratio of the first solvent in the step 1:OAM in the step 2 may be 1:0.01 to 1:0.1.

In the foregoing preparation method of the CsPbBr₃ perovskite nanocrystals of the present disclosure, the volume ratio of the precursor solution in the step 4:the third solvent in the step 4 may be 1:4 to 1:6.

In the foregoing preparation method of the CsPbBr₃ perovskite nanocrystals of the present disclosure, the PTCDA solution dissolved in the second solvent may have a concentration of 4 mM to 6 mM.

### Examples

### [Synthesis of PTCDA-Doped CsPbBr₃ Perovskite Nanocrystals]

CsBr and PbBr₂ were dissolved in dimethylformamide (DMF), and stirred for 5 to 15 minutes. Then, oleic acid (OA) and oleylamine (OAM) were added, and stirred for another 5 to 15 minutes, forming a mixture. A PTCDA solution dissolved in DMF was added into the foregoing mixture, thereby forming PTCDA-doped CsPbBr₃ perovskite precursor solution. Then, react the CsPbBr₃ perovskite precursor solution with toluene for 0.5 to 2 minutes, then centrifuged to remove the supernatant, thereby obtaining the PTCDA-doped CsPbBr₃ perovskite nanocrystals (PTCDA-PVSK). PTCDA-PVSK was stored in octane. The molar ratio of CsBr:PbBr₂:PTCDA was 1:1:0.002 to 1:1:0.003; the volume ratio of DMF:OA was 1:0.05 to 1:0.2; the volume ratio of DMF:OAM was 1:0.01 to 1:0.1; and, the volume ratio of the precursor solution:toluene was 1:4 to 1:6.

The CsPbBr₃ perovskite nanocrystal (PVSK) as the comparative example was prepared with the same method as described above, except that the step of adding the PTCDA solution during the preparation of the CsPbBr₃ perovskite precursor solution was omitted.

### [Preparation of Perovskite Films]

Indium tin oxide (ITO) was washed with neutral detergent and deionized water three times and dried with N₂. Subsequently, 80 μL of poly-L-lysine as an electron transfer layer was dropped onto the ITO surface. Spin coating was then performed at 2000 rpm for 30 sec and 3000 rpm for 10 sec to form a thin film, followed by drying and cooling at 80° C. Next, 50 μL of the PTCDA-PVSK or PVSK solution was spin-coated onto the electron transfer layer with the same manner for 5 times. The thin film was heated at 80° C. for 10 minutes and then cooled to room temperature.

### [Properties of Perovskite Films]

The UV-visible absorption spectrum of the perovskite was measured using a JASCO V-630 spectrophotometer at a wavelength of 365 nm, with a scan range of 400 to 800 nm. As shown in FIG. 1, the absorption peak of PVSK was about 507 nm, while that of PTCDA-PVSK was about 517 nm.

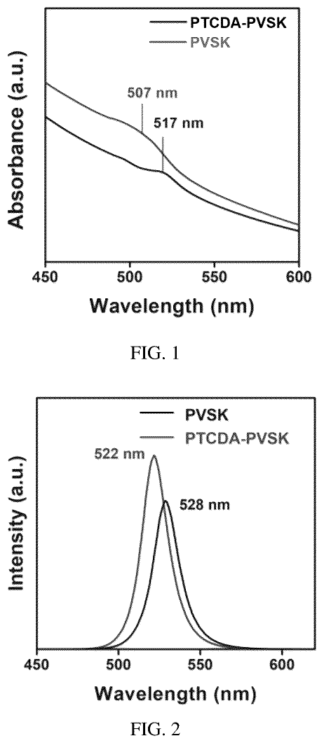

The photoluminescence (PL) spectrum was measured using a fluorescence spectrophotometer (F-7000, Hitachi, Japan) with an Xe laser light source at a wavelength of 370 nm, and a scan range of 300 to 800 nm. As shown in FIG. 2, the emission peak in the PL spectrum of PVSK was about 528 nm, while that of PTCDA-PVSK was about 522 nm.

It is known that defects in crystals can cause a reduction in radiative energy and a redshift in the emission peak of the emission spectrum. The PL emission peak of PTCDA-PVSK of the present disclosure exhibited a blueshift in wavelength, along with an increase in emission intensity. This indicates that adding PTCDA as a dopant into CsPbBr₃ perovskite can enhance the optical properties of the perovskite.

Next, Fourier-transform infrared (FTIR) spectroscopy was used to analyze the bonding between PTCDA and CsPbBr₃ perovskite in PTCDA-PVSK. The FTIR spectrum of the perovskite was measured using an FTIR spectrometer (Spectrum Two; PerkinElmer, USA) with a resolution of 4 cm⁻¹, 8 scans, and a scan range of 400 to 4000 cm⁻¹.

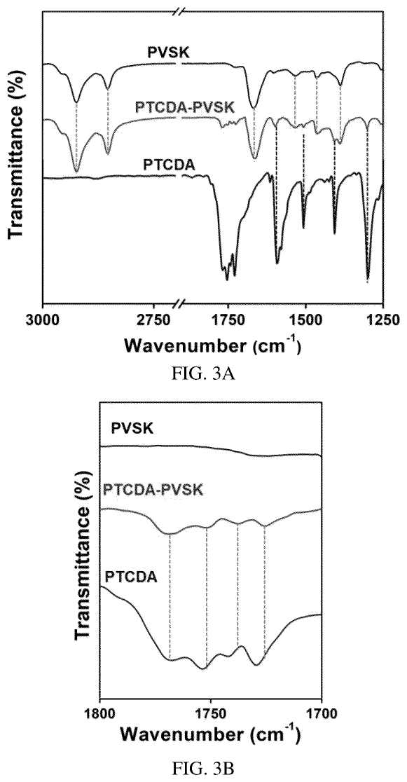

As shown in FIGS. 3A and 3B, the peaks at 1730 and 1742 cm⁻¹ in the spectrum of PTCDA represented the symmetric stretching of C═O, while the C═O stretching signals in the PTCDA-PVSK spectrum shift to lower wavenumbers, specifically 1725, 1737, 1751, and 1767 cm⁻¹. This decrease in electron cloud density suggests that the electron cloud of the C═O group has moved from the bond center toward the lead atom. Thus, it can be inferred that there is bonding between the oxygen atoms of the C═O groups in PTCDA and the lead atoms.

### [Stability of the Perovskite]

To evaluate the stability of the PTCDA-PVSK of the present disclosure in high-humidity environments, the perovskite film was exposed to low-humidity (RH25%) or high-humidity (RH75%) environments for 1 hour, and changes in the following properties were observed.

### Fluorescence Stability

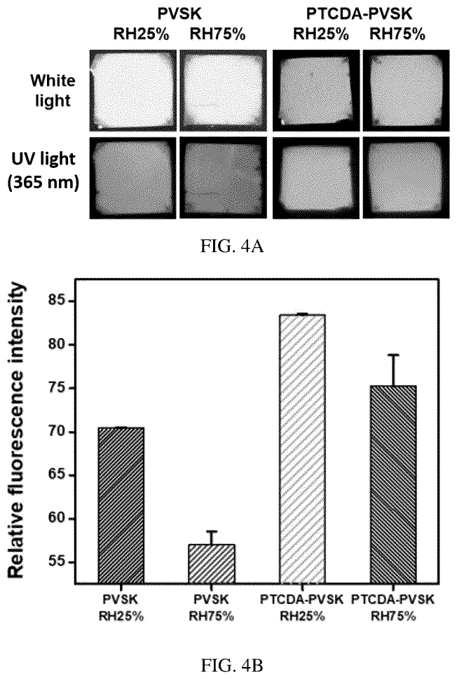

As shown in the digital images in FIGS. 4A and 4B, the fluorescence intensity of the PVSK film significantly decreased under high humidity (RH75%) compared to low humidity (RH25%). In contrast, the PTCDA-PVSK film maintained stable and higher fluorescence intensity under both low humidity (RH25%) and high humidity (RH75%) conditions.

### Surface Morphology

PVSK exhibited a uniform granular morphology under low humidity (RH25%). However, under high humidity (RH75%), the PVSK particles appeared larger. In contrast, the granular morphology of PTCDA-PVSK remained almost unaffected under both low humidity (RH25%) and high humidity (RH75%) conditions.

### Root Mean Square (RMS) Roughness

The surface morphology of the perovskite was further analyzed using an Atomic Force Microscope (AFM) (model: MFP-3DTM, Asylum, USA).

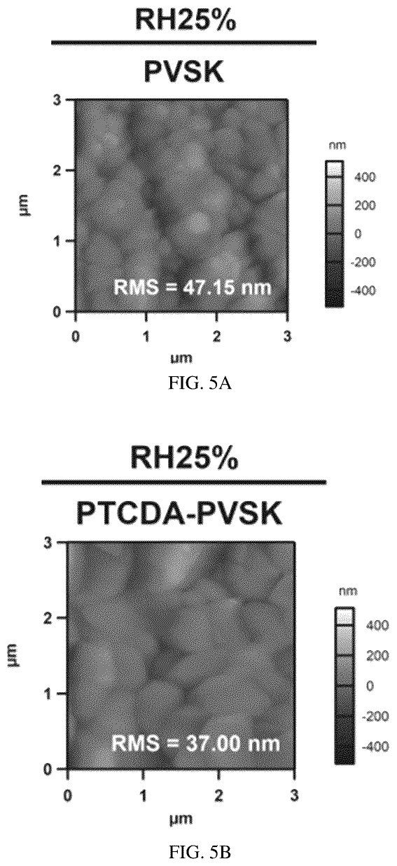

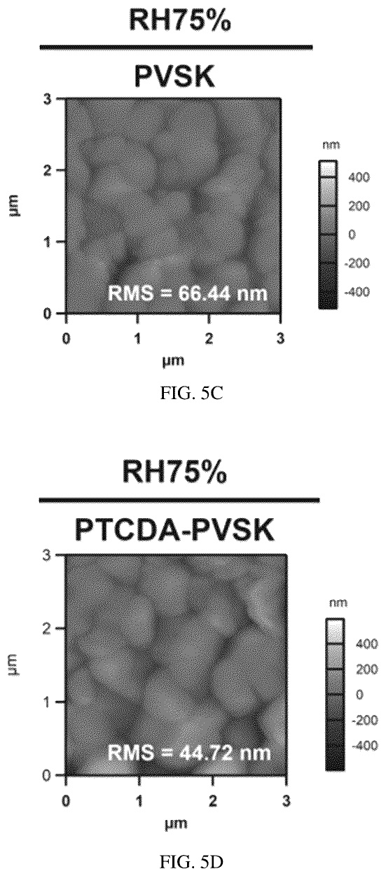

As shown in FIGS. 5A and 5B, at low humidity (RH25%), the surface morphology of PTCDA-PVSK was smoother than that of PVSK, with the root mean square (RMS) roughness of 37.00 nm and 47.15 nm for PTCDA-PVSK and PVSK, respectively. As shown in FIGS. 5C and 5D, when exposed to high humidity (RH75%), the grain size of PVSK increased with the RMS roughness rising to 66.44 nm, indicating that PVSK easily reacts with water molecules and degrades at high humidity (RH75%). In contrast, at high humidity (RH75%), the RMS roughness of PTCDA-PVSK was 44.72 nm, showing little change in surface morphology of PTCDA-PVSK compared to low humidity (RH25%), demonstrating that doping with PTCDA can effectively prevent degradation of the perovskite under high-humidity conditions.

### Changes in Work Function

Additionally, the contact potential difference (V_{CPD}) of PTCDA-PVSK and PVSK at low humidity (RH25%) and high humidity (RH75%) was also measured using scanning Kelvin probe microscopy (SKPM), and the work function of the perovskite samples (Øₛₐₘₚₗₑ) was calculated using formula (1). An AC240TM conductive probe was used, with the probe tip positioned 30 nm from the surface of the perovskite sample and an AC voltage of 3 V applied during measurement. It is known that work function of the probe (Ø_{probe}) is approximately 4.97 eV.

$${V}_{CPD} = \frac{{∅}_{tip} - {∅}_{sample}}{e} \qquad formula ( 1 )$$

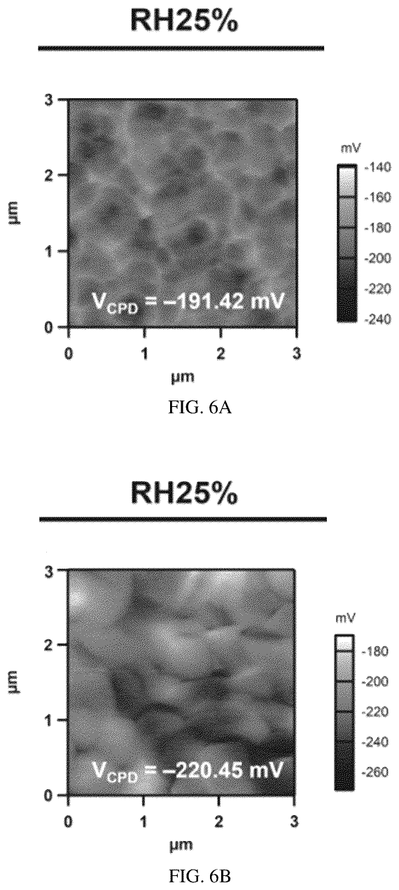

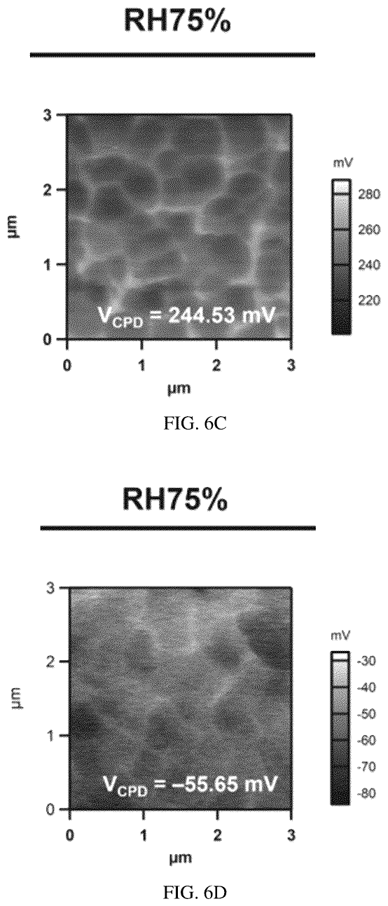

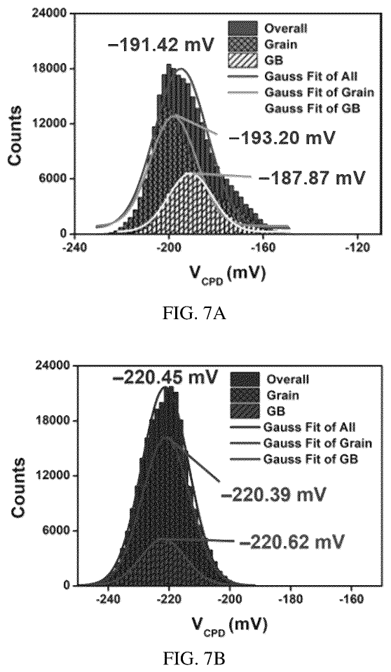

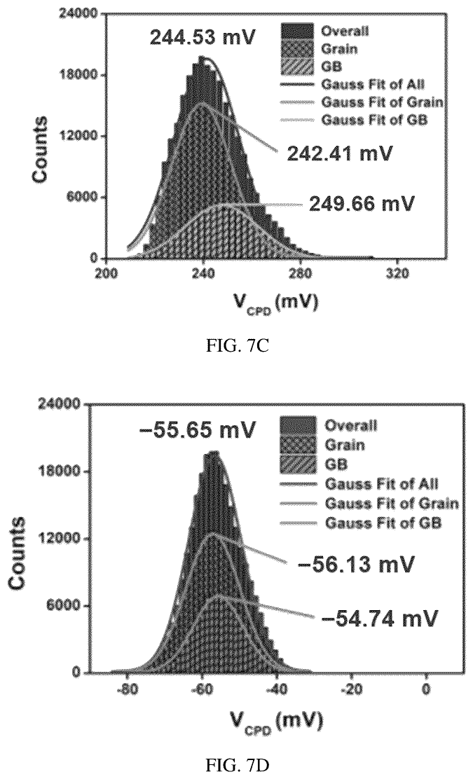

FIGS. 6A, 6B, 6C, and 6D showed the surface potential maps of the corresponding regions in FIGS. 5A, 5B, 5C, and 5D. FIG. 6A shows the surface potential map of PVSK, where the bright regions indicate a higher V_{CPD} at low humidity (RH25%). Compared with the surface morphology in FIG. 5A, it can be observed that the potential at the grain boundaries was higher than that at the grains. The statistical histogram of surface potential in FIG. 7A shows that the average V_{CPD} of PVSK grains at low humidity (RH25%) was 193.20±0.66 mV, while the average V_{CPD} at the grain boundaries was 187.87±1.76 mV, resulting in a potential difference of 5.33 mV. When the humidity increases to high humidity (RH75%), FIG. 6C shows that the V_{CPD} at the PVSK grain boundaries was significantly higher than that at the grains. FIG. 7C indicated that under high humidity (RH75%), the average V_{CPD} of PVSK grains and grain boundaries was 242.41±3.44 mV and 249.66±5.45 mV, respectively, with a potential difference of 7.25 mV between the grain boundaries and grains. As the environmental humidity increases, the overall work function of PVSK decreased from 5.16±0.01 eV (low humidity, RH25%) to 4.73±0.01 eV (high humidity, RH75%), indicating a total decrease of 0.43 eV.

When PTCDA-PVSK was exposed to low humidity (RH25%), as shown in FIG. 6B, the V_{CPD} difference between the grains and grain boundaries of PTCDA-PVSK was reduced compared to that of PVSK. As shown in FIG. 7B, the average V_{CPD} of PTCDA-PVSK grains and grain boundaries were 220.39±6.28 mV and 220.62±6.31 mV, respectively, with a potential difference of 0.23 mV between the grain boundaries and grains, indicating that doping with PTCDA can effectively reduce electron accumulation at the grain boundaries. As shown in FIG. 7D, under high humidity (RH75%), the V_{CPD} difference between the grains and grain boundaries of PTCDA-PVSK remained small, with a potential difference of 1.39 mV. When the environmental humidity increased, the overall work function of PTCDA-PVSK changed from 5.19±0.01 eV (low humidity, RH25%) to 5.03±0.01 eV (high humidity, RH75%), decreasing by only 0.16 eV. This indicates that the conjugated structure of PTCDA can facilitate electron transfer between grains, effectively mitigating electron accumulation at the grain boundaries while preventing the influence of water molecules.

### XRD Patterns

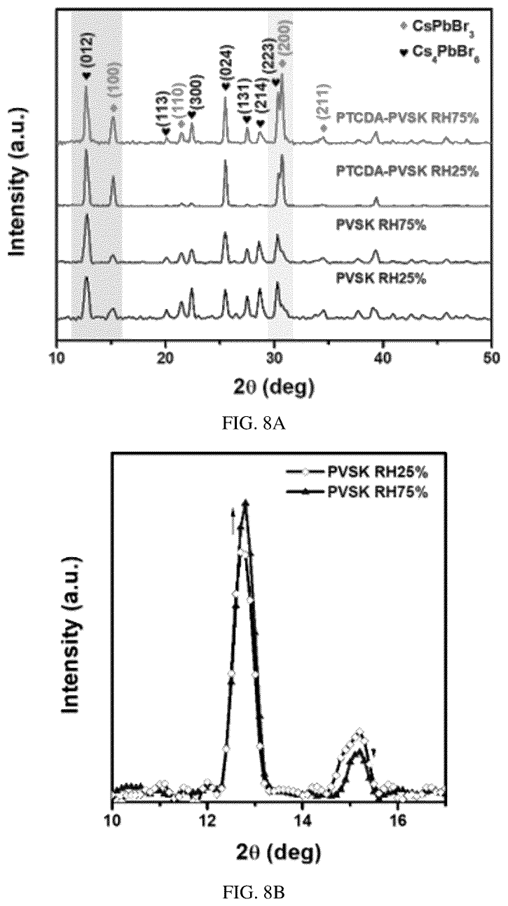

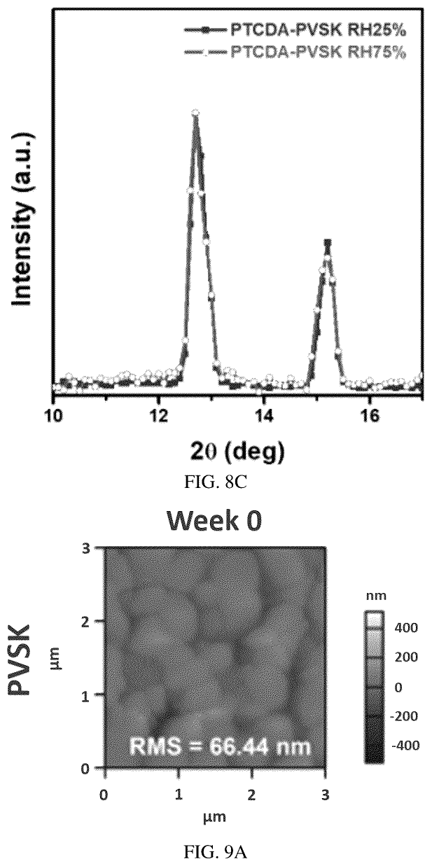

As shown in the XRD patterns in FIG. 8A, the crystal structures of both PVSK and PTCDA-PVSK consisted of CsPbBr₃ and Cs₄PbBr₆. Distinct peaks at lattice angles of 15.2°, 21.5°, 30.7°, and 34.4° represented the (100), (110), (200), and (211) crystal planes of CsPbBr₃, respectively (referencing JCPDS No. 18-0364). Peaks at lattice angles of 12.7°, 20.1°, 22.4°, 25.5°, 27.5°, 28.7°, 30.3°, and 39° represented the (012), (113), (300), (024), (131), (214), (223), and (330) crystal planes of Cs₄PbBr₆ (referencing JCPDS No. 73-2478). The peaks at lattice angles 30.3° (223) and 30.7° (200) indicated that, compared to PVSK, PTCDA-PVSK exhibited a stronger CsPbBr₃ crystal signal at both low humidity (RH25%) and high humidity (RH75%), while PVSK showed a higher proportion of Cs₄PbBr₆ crystals. Additionally, as shown in FIG. 8B, a slight degradation of CsPbBr₃ crystals (lattice angle 15.2° (100)) was observed in PVSK at high humidity (RH75%) conditions, simultaneously representing an increased intensity of Cs₄PbBr₆ crystal signals (lattice angle 12.7° (012)). In contrast, as shown in FIG. 8C, the crystal composition of PTCDA-PVSK at high humidity (RH75%) remained largely unchanged.

### Changes in Surface Adhesion

When stored in a high-humidity environment, the adhesion values of PVSK increased over time. In contrast, the adhesion of the grains and grain boundaries in PTCDA-PVSK showed no significant change. This indicates that the hydrophobicity of the conjugated structure of the PTCDA ligand allows PTCDA to form a protective layer on the perovskite surface, reducing direct contact between water molecules and the crystal surface, thereby effectively reducing degradation of the perovskite caused by water molecules.

### [Long-Term Stability of the Perovskite]

To evaluate the long-term stability of the perovskite films, the perovskite films were exposed to a high-humidity environment (RH75%) for four weeks, and changes in the surface morphology and surface potential of PVSK and PTCDA-PVSK films were measured.

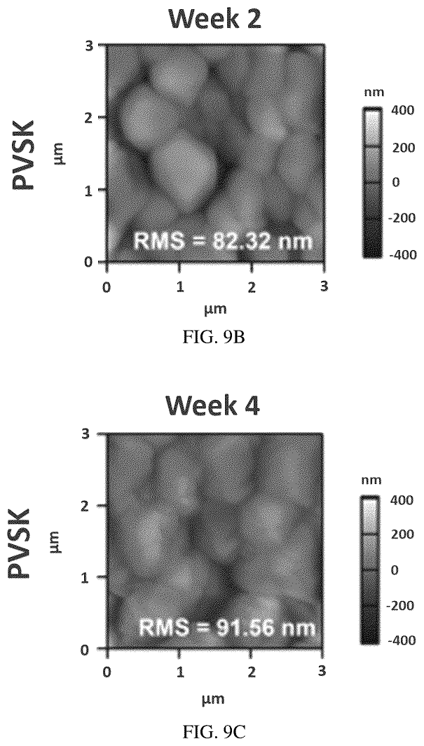

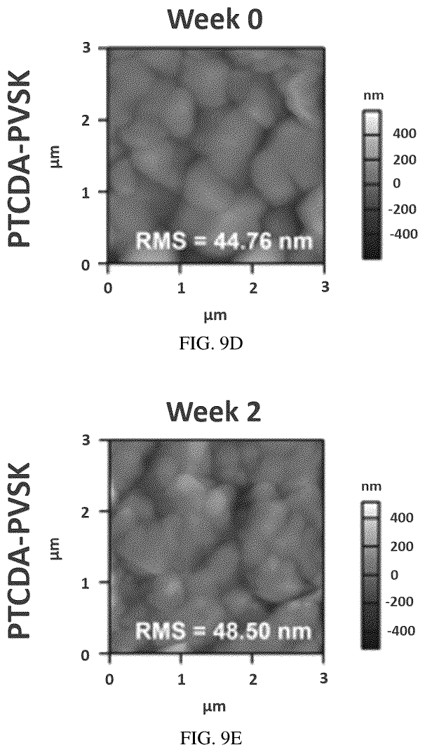

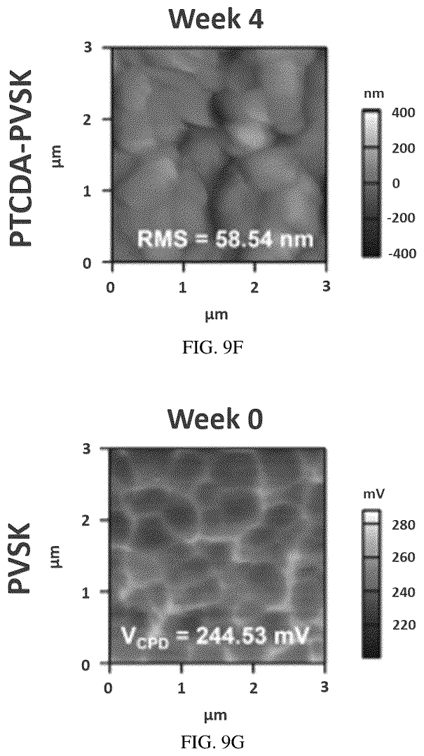

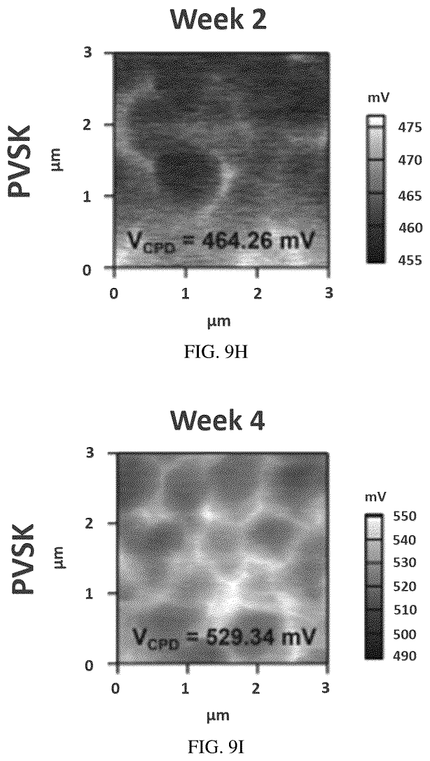

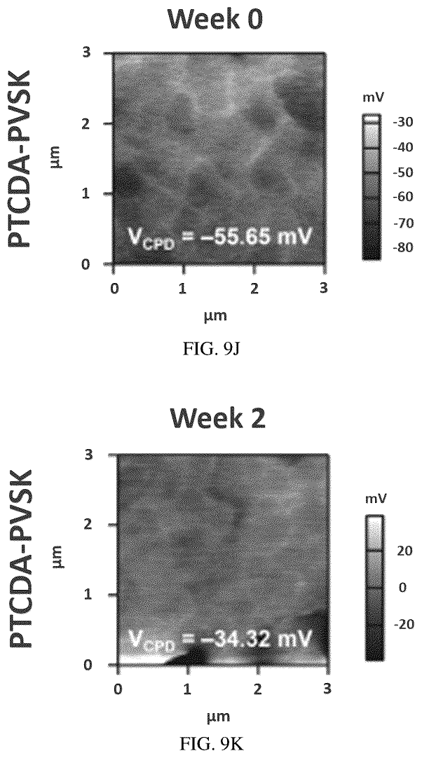

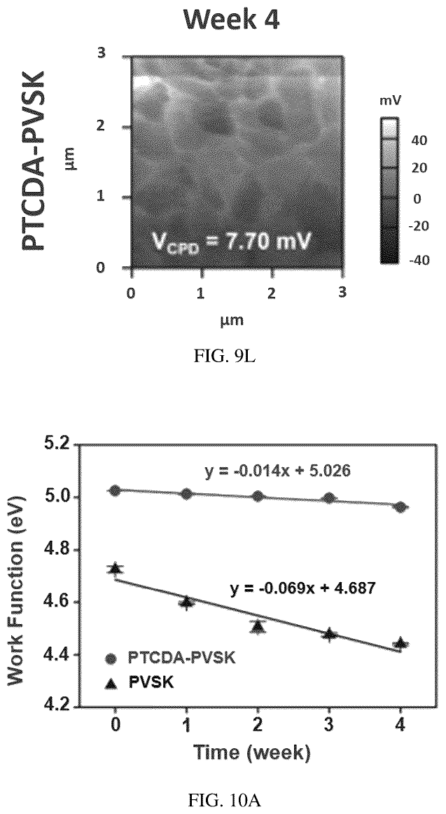

As shown in FIGS. 9A, 9B, 9C, 9D, 9E, 9F, 9G, 9H, 9I, 9J, 9K, and 9L, although the RMS roughness and surface potential of both PVSK and PTCDA-PVSK films gradually increase with prolonged exposure to a high-humidity environment (RH75%), the RMS roughness and surface potential difference between the grains and grain boundaries of PTCDA-PVSK remained relatively stable compared to PVSK.

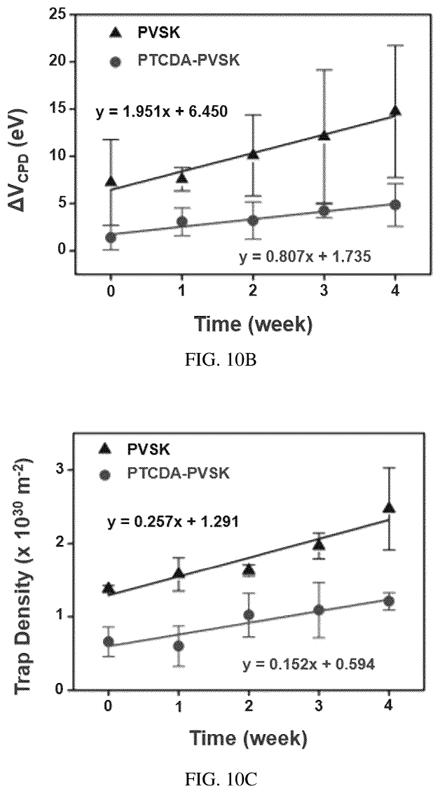

As shown in FIGS. 10A, 10B, and 10C, all the slopes for PVSK in the work function analytical graph, surface potential analytical graph, and defect density analytical graph were steeper than those for PTCDA-PVSK, indicating that, compared to PTCDA-PVSK, PVSK exhibited more significant changes in work function, surface potential, and defect density after four weeks. Specifically, as shown in FIG. 10A, the work function of PVSK gradually decreases from 4.73 eV to 4.44 eV, a decrease of 0.29 eV. In contrast, the work function of PTCDA-PVSK shows a smaller change, decreasing slightly from 5.03 eV to 4.96 eV, a difference of 0.07 eV. Additionally, as shown in FIG. 10B, after four weeks, the surface potential difference between the grains and grain boundaries of PVSK increases from 7.25 mV to 14.74 mV, a total increase of 7.49 mV, while for PTCDA-PVSK, it increases from 1.39 mV to 4.86 mV, an increase of only 3.47 mV. Furthermore, Gaussian fitting was employed to extract two parameters: the potential difference between the grain boundaries and grains (ΔØGB) and the width of the effective charge region at the grain boundary (WGB). These two parameters were used in formulas (2) and (3) to calculate the net doping density (Pₙₑₜ) and defect density at the grain boundary (P_{GB-trap}). The average value was taken after analyzing three different positions on each image. As shown in FIG. 10C, the defect density of PVSK increased over time, with a slope of 0.257. In contrast, the slope for PTCDA-PVSK was 0.152, indicating that doping with PTCDA can inhibit the increase in defect density in the perovskite film under high-humidity conditions.

$${P}_{net} = \frac{2 {ε}_{0} {ε}_{r} Δ {∅}_{GB}}{{e}^{2} {W}_{GB}^{2}} \qquad formula ( 2 )$$

$${P}_{GP - trap} = \frac{1}{e} \sqrt{8 {ε}_{0} {ε}_{r} {P}_{net} Δ {∅}_{GB}} \qquad formula ( 3 )$$

### [Optoelectronic Properties of the Perovskite]

To evaluate the optoelectronic properties of the perovskite films under high humidity, the perovskite films were exposed to a high-humidity environment (RH75%) for four weeks while being illuminated with light having a wavelength of 365 nm. The optoelectronic properties of PTCDA-PVSK and PVSK before and after 365 nm illumination were then measured.

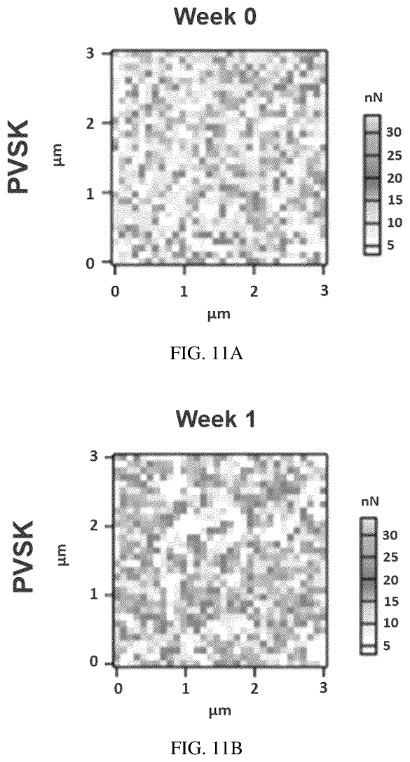

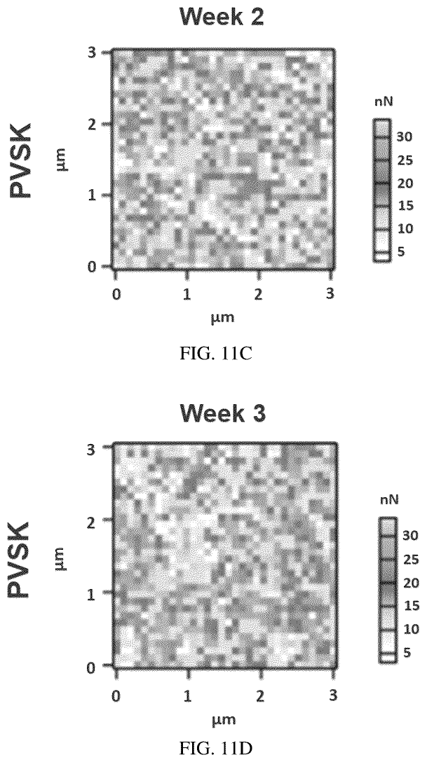

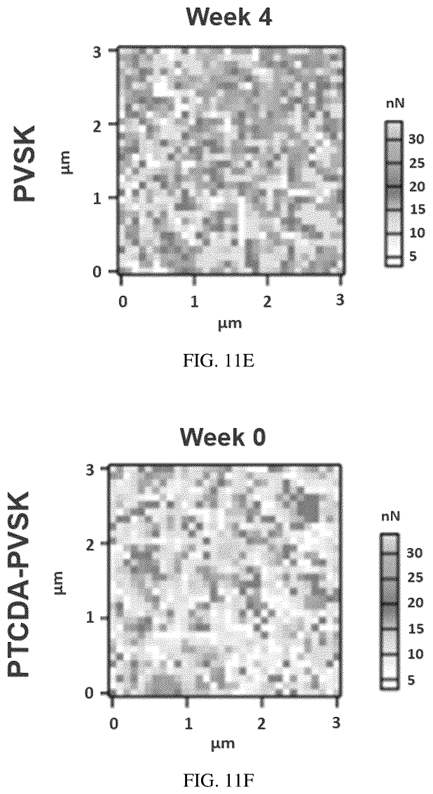

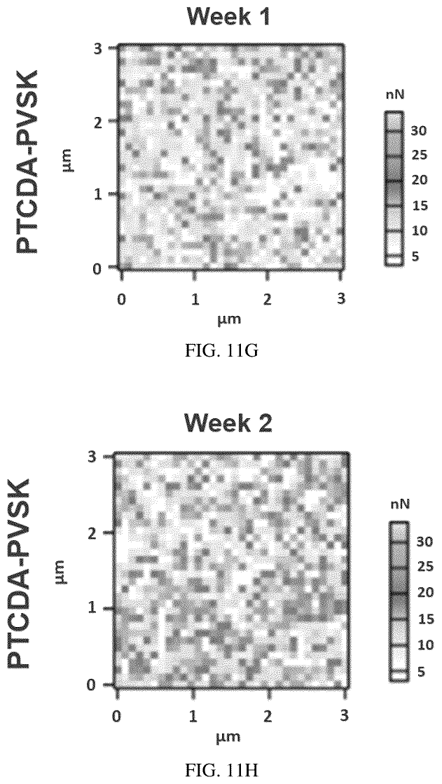

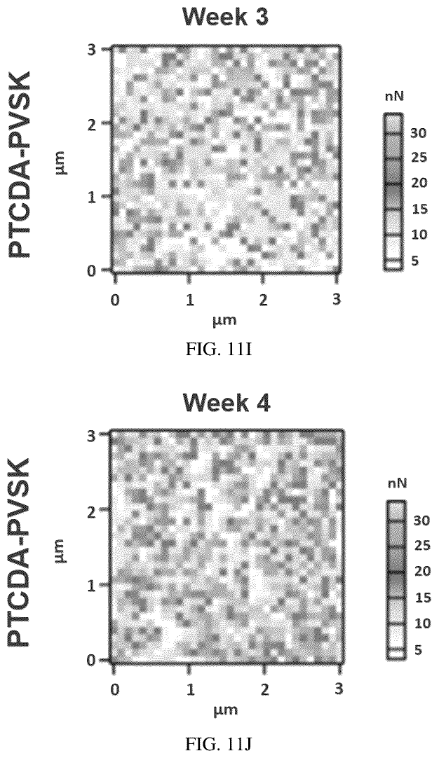

As shown in the adhesion distribution images in FIGS. 11A, 11B, 11C, 11D, 11E, 11F, 11G, 11H, 11I, and 11J, the contrast between grains and grain boundaries in PVSK increased after illumination (see FIG. 11C). On the contrary, the contrast between grains and grain boundaries in PTCDA-PVSK did not show a significant change after illumination (see FIGS. 11G and 11H). Additionally, as shown in the yellow region of FIG. 11I, the V_{CPD} at the grain boundaries remained nearly unchanged. Although both PVSK and PTCDA-PVSK exhibited an overall upward trend in V_{CPD} after illumination, with increases of 37.5 mV and 121 mV, respectively (see FIGS. 11E and 11J), the calculated energy conversion efficiency of PTCDA-PVSK is 3.56%, which is higher than the 1.10% of PVSK. The energy conversion efficiency of PTCDA-PVSK is approximately 3.2 times higher than that of PVSK. These results indicate that PTCDA can serve as a bridge for electron transport, effectively transferring photogenerated electrons and directing more photogenerated electrons towards the electron transport layer, thus enhancing the performance of optoelectronic devices in future applications.

The terms used in this specification are for the purpose of describing particular embodiments only and is not intended to limit the present disclosure. As used in the present disclosure, the singular forms “a”, “an” and “the” do not imply a limitation on quantity and should be interpreted as including the plural form unless the context explicitly indicates otherwise.

All ranges disclosed in the present disclosure encompass the endpoints and all combinations of endpoints and intermediate values. The term “combinations thereof” includes one or more of the listed elements and is inclusive. It should also be understood that, as used in this specification, the term “comprising” specifies the presence of stated features, components, steps, and/or elements, but does not preclude the presence or addition of one or more other features, components, steps, elements, and/or combinations thereof.

The term “aspect” refers to the relevant description of the aspect that may be included in at least one aspect of the present disclosure and may or may not be present in other aspects.

While preferred embodiments have been described, it should be understood that those skilled in the art, now and in the future, can make various improvements and modifications that fall within the scope of the appended claims. These claims should be interpreted to maintain proper protection for the original disclosure.

What is claimed is:

1. A CsPbBr₃ perovskite nanocrystal, characterized by doping with 3,4,9,10-perylenetetracarboxylic dianhydride (PTCDA), wherein the PTCDA forms bonds with lead atom in the CsPbBr₃ perovskite nanocrystal via oxygen atom of C═O group, and is interspersed between the CsPbBr₃ perovskite nanocrystals.

2. The CsPbBr₃ perovskite nanocrystal of claim 1, wherein the CsPbBr₃ perovskite nanocrystal exhibits an absorption peak in UV-visible absorption spectrum within a range of 512 nm to 522 nm.

3. The CsPbBr₃ perovskite nanocrystal of claim 1, wherein the CsPbBr₃ perovskite nanocrystal exhibits an emission peak in photoluminescence (PL) spectrum within a range of 519 nm and 525 nm.

4. The CsPbBr₃ perovskite nanocrystal of claim 1, wherein the CsPbBr₃ perovskite nanocrystal exhibits a potential difference between grains and grain boundaries within a range of 1.34 mV and 1.44 mV at RH75%.

5. A preparation method of the CsPbBr₃ perovskite nanocrystal of claim 1, characterized by adding PTCDA when preparing CsPbBr₃ perovskite precursor solution.

6. The method of claim 5, wherein the method comprises following steps:
Step 1: dissolving CsBr and PbBr₂ in a first solvent;
Step 2: adding oleic acid (OA) and oleylamine (OAM);
Step 3: adding a PTCDA solution dissolved in a second solvent, thereby forming the CsPbBr₃ perovskite precursor solution;
Step 4: reacting the CsPbBr₃ perovskite precursor solution with a third solvent, thereby obtaining the CsPbBr₃ perovskite nanocrystal.

7. The method of claim 6, wherein the first solvent is dimethylformamide (DMF); the second solvent is dimethylformamide (DMF); and the third solvent is toluene.

8. The method of claim 6, wherein the PTCDA solution dissolved in the second solvent has a concentration of 4 mM to 6 mM.

9. A perovskite film comprising the CsPbBr₃ perovskite nanocrystal of claim 1.
